(19) United States
(12) Patent Application Publication
(10) Pub. No.: US 2011/0317858 A1
(43) Pub. Date: Dec. 29, 2011

(54) HEARING AID APPARATUS

(76) Inventor: Yat Yiu CHEUNG, Hong Kong (HK)

(21) Appl. No.: 13/227,451

(22) Filed: Sep. 7, 2011

Related U.S. Application Data
(63) Continuation-in-part of application No. 12/127,839, filed on May 28, 2008.

(51) Int. Cl. H04R 25/00

(52) U.S. Cl. 381/317

(57) ABSTRACT

A hearing aid frontend device for frontend processing of ambient sounds. The frontend device is adapted for wearing use by a user and comprises first and second sound collectors adapted for collecting ambient sound with spatial diversity. The sounds collected by the sound collectors are processed by a sound processor. The sound process comprises a digital signal processor for beamforming sounds collected by the first and second collectors, and the processed sounds are subsequently subject to adaptive noise cancellation.

### CROSS REFERENCE TO RELATED PATENT APPLICATION

This is a continuation-in-part application of U.S. patent application Ser. No. 12/127,839 filed on 28 May 2008, the entire content of which is hereby incorporated by reference.

### BACKGROUND

Hearing aid apparatus are useful for people with impaired hearing. A typical hearing aid comprises an ear piece mounted with a microphone for collecting ambient sound and an amplifier for amplifying the collected sound. However, the sound quality of conventional hearing aid apparatus is not satisfactory.

Various sound quality enhancing techniques have been proposed to enhance sound quality of hearing aid apparatus.

For example, WO 97/40645 discloses a directional acoustic receiving system in the form of a necklace and including an array of microphones mounted on a housing supported on the chest of a user. Such a system requires a division of audio frequency by the microphones and the quality of sound is still unsatisfactory.

WO 2007/052185 discloses a hearing aid system in which a plurality of sound detectors is mounted on the side and front portion of an eye-glass frame. Such a system is so heavy, bulky and complicated that the product is not available to the public.

HK1101028A by the same inventor discloses a hearing aid apparatus comprising a pair of ear mounted parts. Each ear mount part comprises a housing having a curved portion for attaching to the rear curved part of a user's ear. A microphone is mounted at the bottom end of the housing and the sound collected by the pair of microphones is processed by an external signal processor using beamforming techniques. However, the apparatus is relatively bulky, the sound quality is not satisfactory and the pair of parts must be worn at the same time in order to work as designed.

Therefore, it would be advantageous if improved hearing aid apparatus can be provided.

### SUMMARY

Accordingly, there is provided a hearing aid frontend device for frontend processing of ambient sounds. The frontend device is adapted for wearing use by a user and comprises first and second sound collectors adapted for collecting ambient sound with spatial diversity. The sounds collected by the sound collectors are processed by a sound processor. The sound process comprises a digital signal processor for beamforming sounds collected by the first and second collectors, and the processed sounds are subsequently subject to adaptive noise cancellation. To achieve spatial diversity and to facilitate spatial selectivity, the first and second sound collectors are arranged such that the transverse separation distance between the sound collectors during use is greater than the face width of a user. In general, the sound processor is adapted to process the ambient sounds collected by the first and second sound collectors and select sounds forward of the user for subsequent noise cancellation and output to the user.

### BRIEF DESCRIPTION OF THE DRAWINGS

Exemplary hearing aid arrangements will be described below by way of example with reference to the accompanying Figures in which:—

FIG. 1 is a front view of a first example hearing aid frontend,

FIG. 2 is a schematic view depicting the frontend of FIG. 1 when worn by a user and in use,

FIG. 3 illustrates the hearing aid frontend of FIG. 1 in a folded configuration,

FIG. 3A is an enlarged view of a portion of FIG. 3,

FIG. 4 is a perspective view showing a second example hearing aid frontend,

FIG. 5 is a schematic diagram depicting a third example hearing aid frontend when worn by a user and in use,

FIG. 6 is a schematic diagram depicting a fourth example hearing aid frontend,

FIG. 7 is a schematic diagram depicting a fifth example illustrating a hearing aid apparatus,

FIG. 8 is a schematic diagram depicting a sixth example illustrating another hearing aid apparatus,

FIG. 9 is a schematic diagram depicting a seventh example illustrating another hearing aid apparatus,

FIG. 10 is a schematic diagram depicting an eight example illustrating yet another hearing aid apparatus,

FIG. 11 is a schematic diagram depicting the hearing aid frontend of FIG. 7 in use,

FIG. 12 shows block diagrams illustrating exemplary signal processing arrangements of the exemplary hearing aid frontends,

FIG. 13 shows exemplary signal processing arrangements of the exemplary hearing aid frontends with more specific details,

FIG. 14 shows block diagrams of an exemplary hearing aid apparatus incorporating the signal processing arrangement of FIGS. 12 and 13, and

FIG. 15 shows another exemplary hearing apparatus incorporating the signal processing arrangement of FIGS. 12 and 13.

### DETAILED DESCRIPTION OF EXEMPLARY EMBODIMENTS

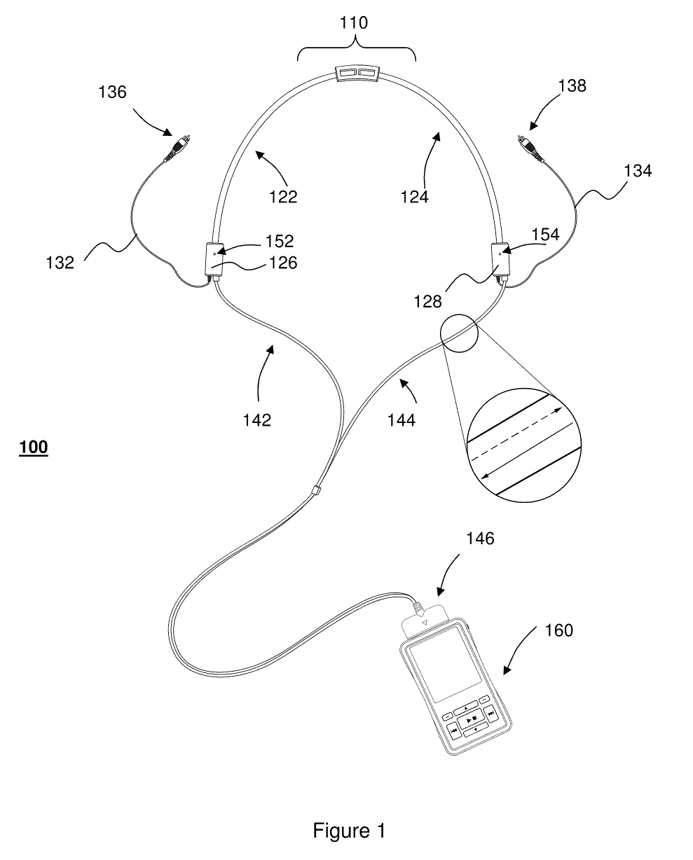

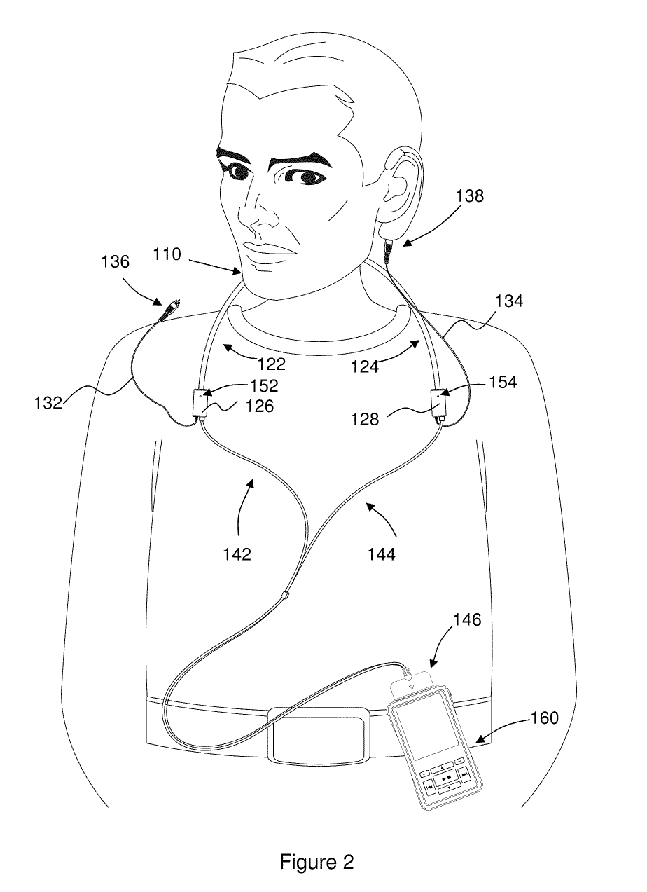

The hearing aid frontend 100 of FIGS. 1 and 2 comprises a neck-mount portion 110 having a curved body comprising first and second curved arms 122,124, a pair of microphone casings 126,128 mounted at the extreme ends of the curved body inside each of which a microphone is mounted, first and second flexible cable portions 132, 134 each extending between a microphone casing and an audio signal output terminal 136, 138, second flexible cable portions 142, 144 each extending between the microphone casing and a signal connector 146, and a signal processing device 160.

The neck-mount portion 110 is adapted for wearing by a user around the back portion of the neck. The first and second curved arms 122, 124 are rigid or semi-rigid so that the separation between the extreme free ends is substantially constant. In addition, the curved body is shaped and configured such that when the curved body is worn by a user, the extreme free ends are forward of the neck of the user at substantially the same vertical level and with a transverse separation larger than the face width of the user. As shown in FIG. 2, microphone casings, which are mounted at the extreme free ends of the curved body, are hanging on the front chest portion of the user proximal the collar bone. The separation of the microphones is set to be between 15 cm to 18 cm for optimal sound output quality.

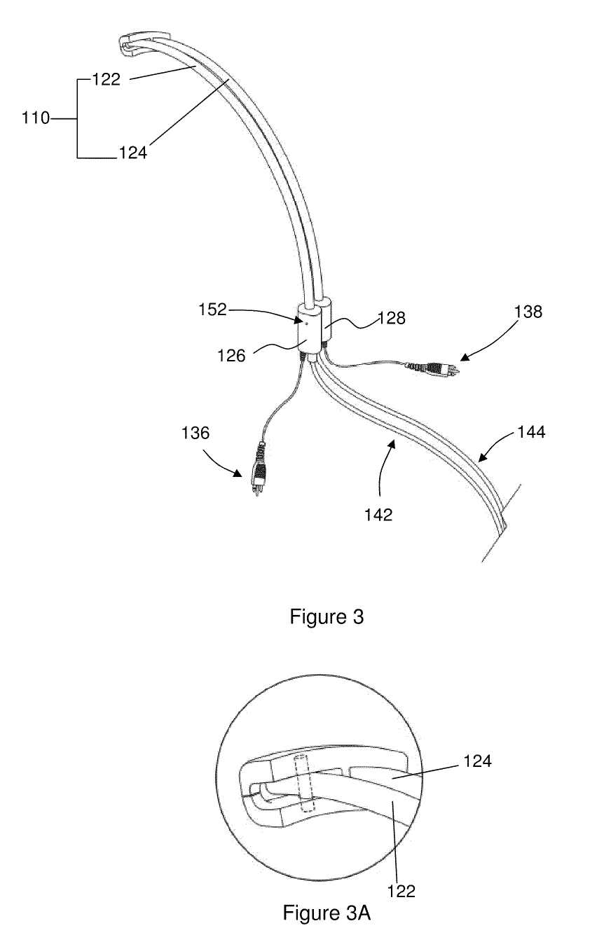

The curved body is foldable about its central axis and about a live joint intermediate the curved arms. The curved body is configured into that shown in FIGS. 3 and 3A when the curved arms are folded, thereby facilitating enhanced portability and storage.

A condenser microphone as an example of a sound collector is mounted inside a moulded plastic casing. An aperture 152, 154 defining an aperture axis which is substantially orthogonal to a plane defined by the pair of curved arms is disposed forward of the user. When the curved body is worn on a user during normal use, the microphone casings are such that the apertures are forward facing with each aperture axis defining a forward direction for reference. More specifically, each microphone is mounted inside a microphone casing with the sound receiving surface of the microphone in forward communication with the aperture. In other words, the sound receiving portion of the microphone is immediately behind the aperture for efficient sound collection.

Ambient sounds collected by the microphones, in the form of electrical signals, are transmitted to the sound processor 160 by flexible cable portions 142, 144. Each flexible signal portion comprises a two-way signal path—a first path for transmitting collected signals to the sound processor for processing and a second path for transmitting audio signal output from the sound processor 160 to the user via the signal output terminals 136, 138.

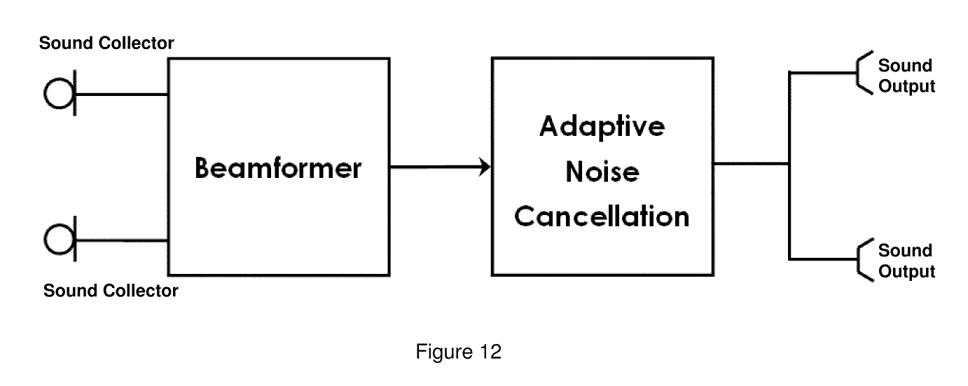

The sounds collected by the microphones are transmitted to the signal processing portion of the sound processor for sound quality enhancement processing. More specifically, the sound processor 160 is adapted to process sound collected by the spaced apart microphones using beamforming techniques to achieve spatial selectivity, and then to further process the signals after beamforming processing with noise cancellation techniques to further enhance sound quality as shown in FIG. 12.

Beamforming is a signal processing technique used in sensor arrays for directional signal transmission or reception to achieve spatial selectivity. This is achieved by combining signals coming from spaced-apart sensor elements in the array in such a way that signals at particular angle experience constructive interference and while others experience destructive interference. Beamforming technique is used at the receiver side to achieve spatial selectivity in hearing aid applications.

In the exemplary applications, the spaced apart microphones are deployed as an array of sound detectors for providing a source of signal diversity for beamforming, thereby achieving spatial selectivity. Specifically, beamforming techniques are used to improve sound reception quality by selecting sound coming from the forward direction and filtering off spurious sounds coming from the lateral side of the user. As a convenient example, the forward direction is set to be at ±30° with respect to the forward axis of a user. The forward axis is defined herein as an axis orthogonal to the body central axis and extending forward of a user.

To provide an appropriate spatial diversity for beamforming audio signals, the microphones are separated at a distance of between 15 cm-18 cm. Such a separation distance has been shown to produce an enhanced Signal-to-Interference Ratio (SIR) compared to conventional hearing aid apparatus.

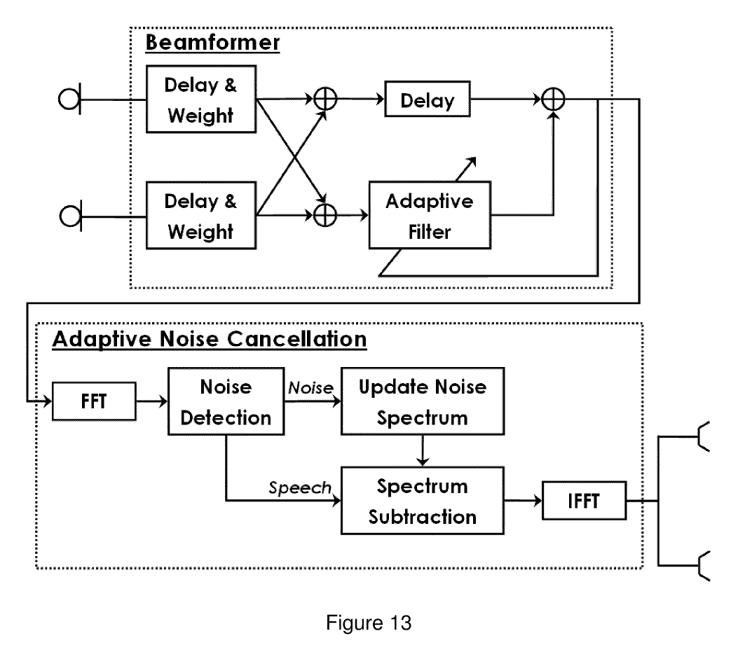

In an example as depicted in the block diagrams of FIG. 13, the signal processing portion of the sound processor is adapted to apply a technique of fixed beamforming using generalized sidelobe cancellation (GSC) to process the signals received from the two microphones. In the first stage of GSC, the delay-and-sum beamforming algorithm is applied to the two signals received from the two microphones to suppress interference and to approximate a desired signal of the listening sound. In the second stage of GSC, a reference interfering signal is approximated by the delay-and-subtract version of the signals received from the two microphones. Least Mean Squared (LMS) adaptation algorithm is then applied to the delay-and-sum beamformed signal obtained from the first stage as the input noisy signal and the delay-and-subtract signal as the reference interference to further improve the SIR. An Adaptive Noise Cancellation (ANC) algorithm is then applied to suppress background noise to obtain a better signal-to-noise ratio (SNR), so that the sound appearing at the ear of a user is more distinguishable. The output of the sound processor 160 is then transmitted to the signal output terminals for transmission to an ear piece as depicted in FIG. 2.

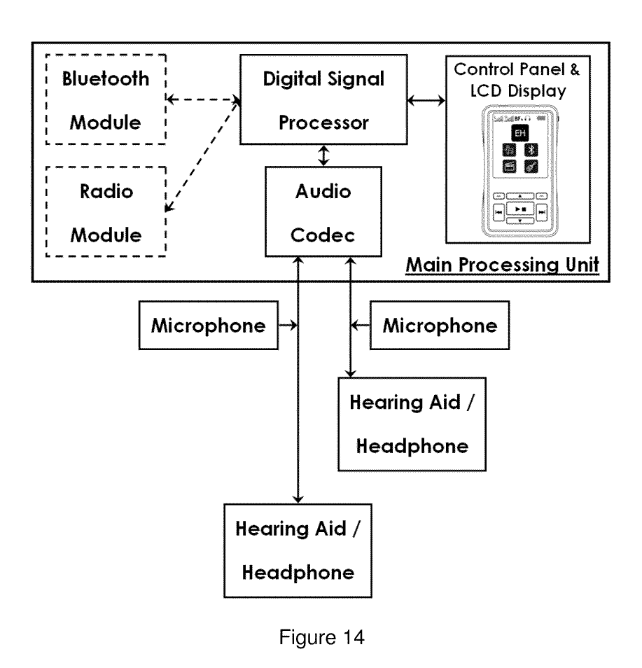

In addition to the signal processing portion which comprises beamforming and noise cancellation portions, the sound processor unit further comprises an audio codec (coder-decoder) portion for converting input analog signal to digital signal and processed digital signal to analog signal for output, as shown in FIG. 14. The received signals are transmitted from the audio codec and then forwarded to a digital signal processor for beamforming and noise cancellation processing.

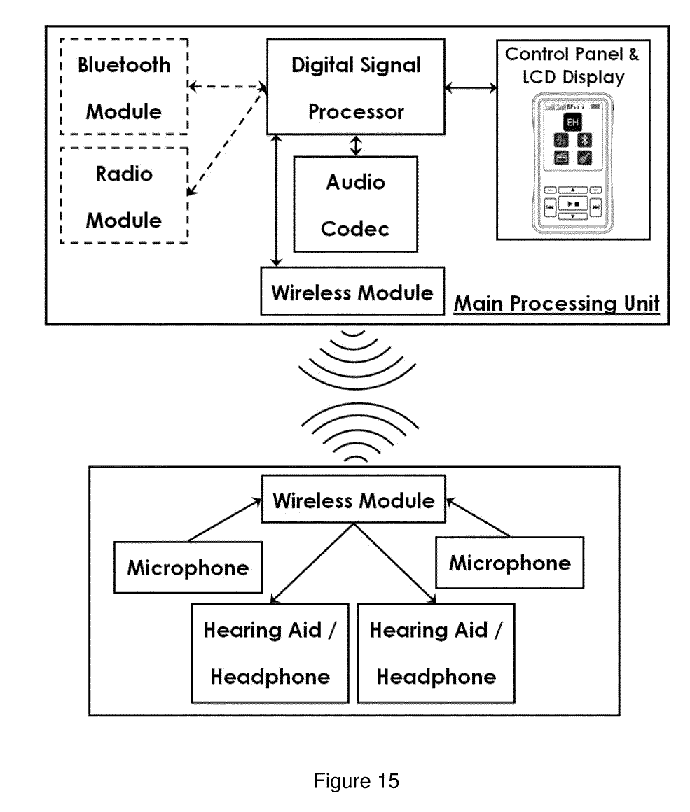

In another example as depicted in FIG. 15, the sound processor is equipped with a bluetooth module as an example of a wireless transceiver to eliminate the need of the flexible cable portions 142 and 144 or their corresponding equivalents.

In use, a user wears the hearing aid frontend 100 in the manner as depicted in FIG. 2, with the microphone apertures forward facing and the signal output terminal 138 connected with an ear piece. After switching on the sound processor, the sound processor will process the sounds collected by the two microphones and then transmit the processed sound to the ear piece.

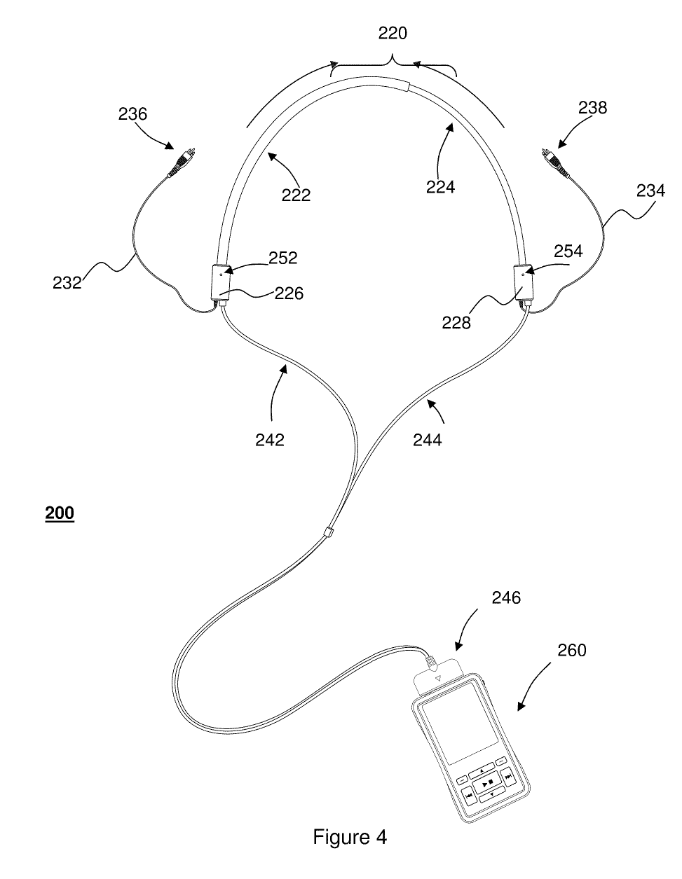

FIG. 4 depicts a second example hearing aid frontend 200, this hearing aid frontend is substantially identical to that of FIG. 1, except that the curved body 220 is arranged such that the second arm is retractable into the first arm. This retractable arm arrangement is advantageous because the transverse separation of the microphones is user adjustable by varying the degree of arm retraction, and the curved body can be collapsed for storage and carriage. As the features of this frontend are substantially identical to that of the first one, descriptions in relation to the first example frontend are incorporated herein by reference with the numerals added by 100.

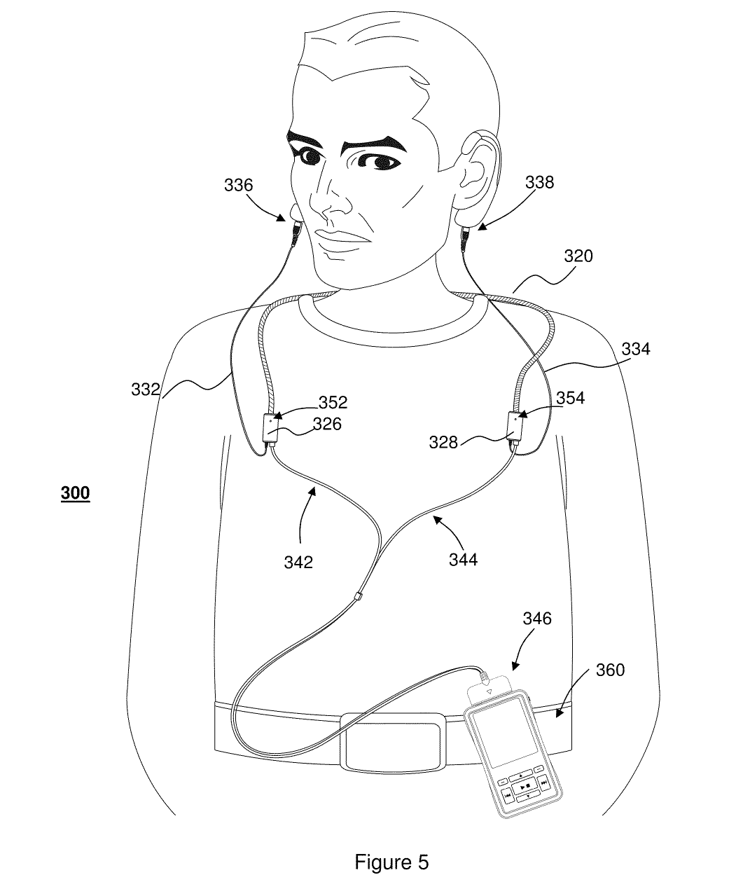

FIG. 5 depicts a third example hearing aid frontend 300, this hearing aid frontend is substantially identical to that of FIG. 1, except that the curved body is replaced by a flexible body 320 of irregular shape such that the separation of the microphone casings is user adjustable. The flexible body means that a good portion of the frontend can be hidden under clothes. As the features of this frontend are substantially identical to that of the first one, descriptions in relation to the first example frontend are incorporated herein by reference with the numerals added by 200.

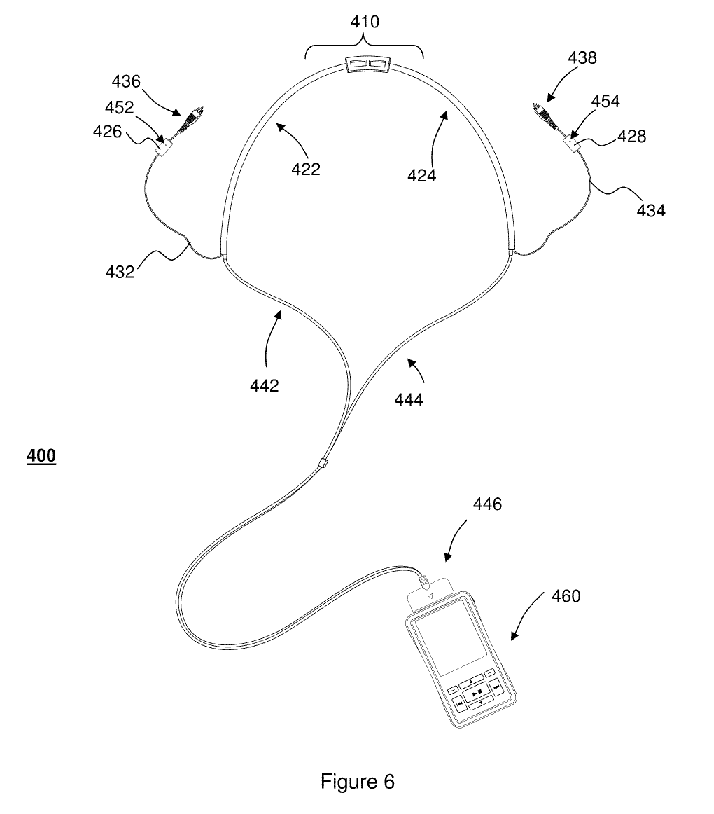

FIG. 6 depicts a fourth example hearing aid frontend 400, this hearing aid frontend is substantially identical to that of FIG. 1, except that the microphone housings are not mounted on the rigid or semi-rigid curved body. Instead, the microphone casings are mounted on the first and second flexible cable portions 432, 434 and at locations between the signal output terminal 436, 438 and the corresponding ends of the curved body. The distance between the microphone casing and a corresponding signal output terminal is adapted such that the microphone casings are proximal the neck portion of a user during use. The flexible mounting also facilitates user adjustable microphone separation. As the features of this frontend are substantially identical to that of the first example, descriptions in relation to the first example frontend are incorporated herein by reference with the numerals added by 300.

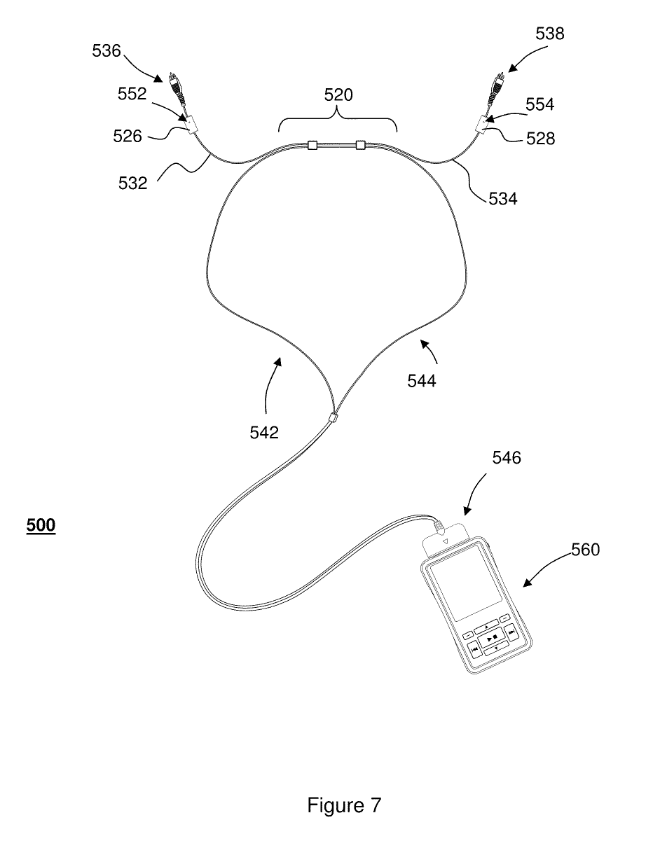

FIG. 7 depicts a fifth example hearing aid frontend 500, this hearing aid frontend is substantially identical to that of FIG. 6, except that the rigid or semi-rigid curved body is replaced by a flexible cable portion. This flexible cable portion 520 is formed by grouping overlapping portions of the first and second cable portions 532, 534. The grouped overlapping portions are bound together by a pair of stops such that the length of the overlapped portions can be changed by varying the location of the stops. It will be noted that the separation distance between the microphone casings could be changed by a user by relatively moving the stops. Likewise, the loop size defined by the overlapped cable portion and the flexible cable portion are adjustable by the moveable stops. As features of this frontend are substantially identical to that of the fourth example, descriptions in relation to the fourth example frontend are incorporated herein by reference with the numerals added by 100.

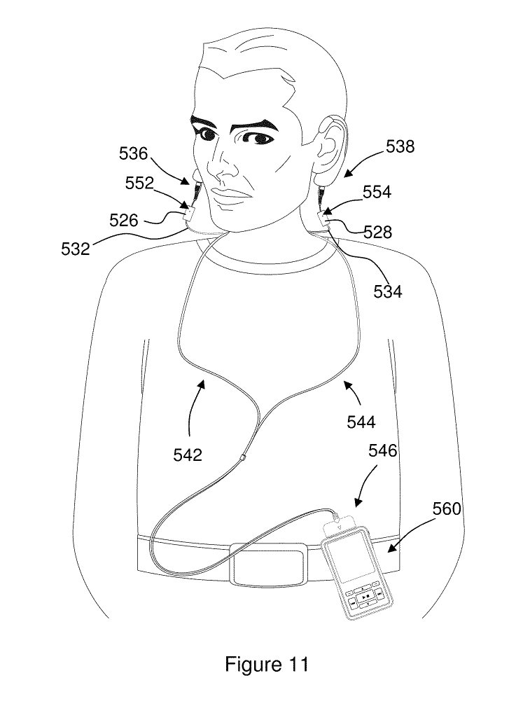

In use, a user wears the frontend with the flexible cable loop around a user's neck as shown in FIG. 11 in a manner such that the flexible cable portion 520 rests against the back of the neck and each microphone casing is forward facing and intermediate the user's ear and shoulder.

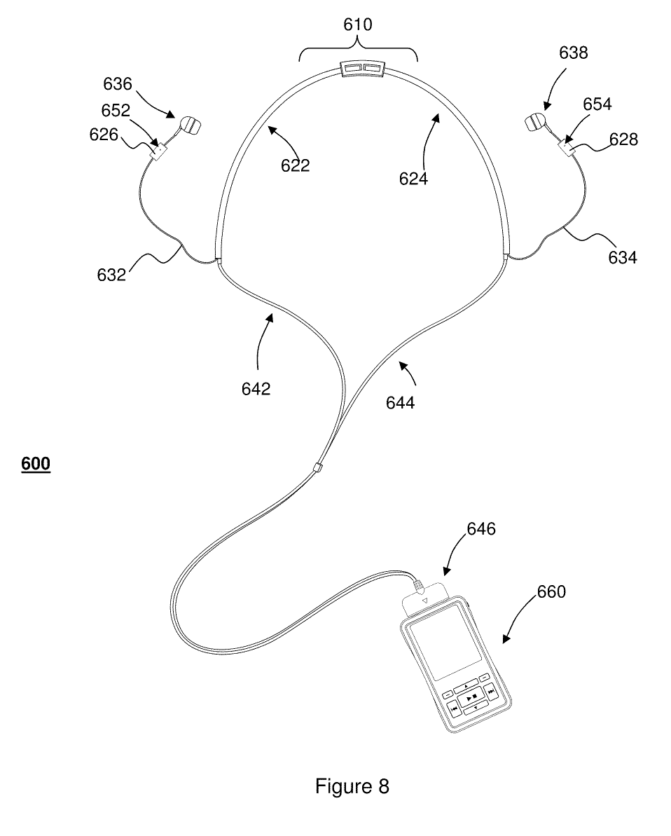

The hearing aid apparatus of FIG. 8 depicts a sixth example hearing aid frontend 600 connected with ear phones, this hearing aid frontend is substantially identical to that of FIG. 6, except that the signal output terminals are replaced with ear phones 636, 638 to form a complete hearing aid apparatus. As the features of this frontend are substantially identical to that of the fourth example, descriptions in relation to the fourth example frontend are incorporated herein by reference with the numerals added by 200.

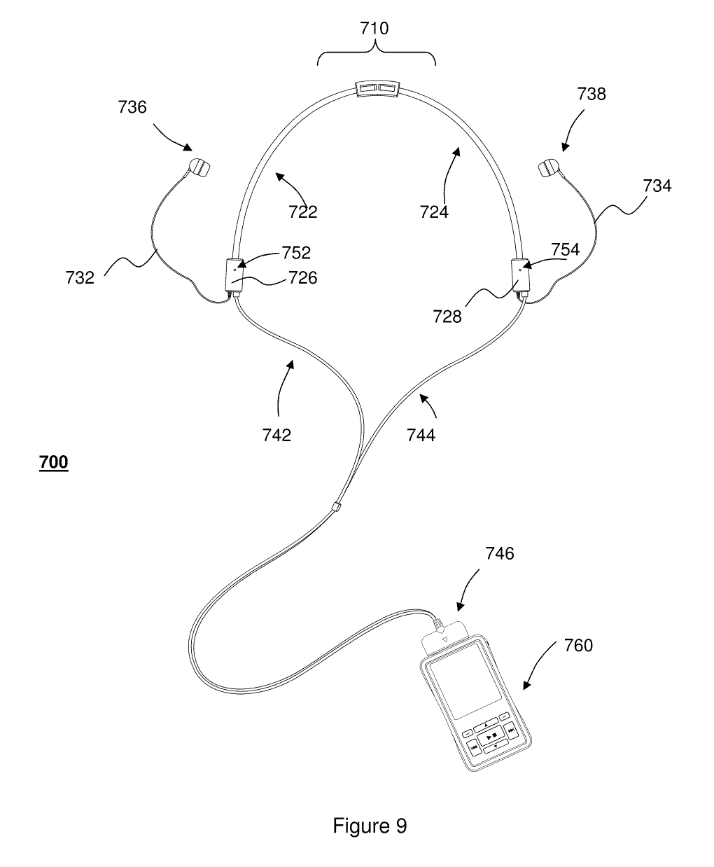

The hearing aid apparatus of FIG. 9 depicts a seventh example hearing aid frontend 700 connected with ear phones, this hearing aid frontend is substantially identical to that of FIG. 6, except that the microphone casings 726,728 are mounted at extreme ends of the curved body. As the features of this frontend are substantially identical to that of the fourth example, descriptions in relation to the sixth example frontend are incorporated herein by reference with the numerals added by 100.

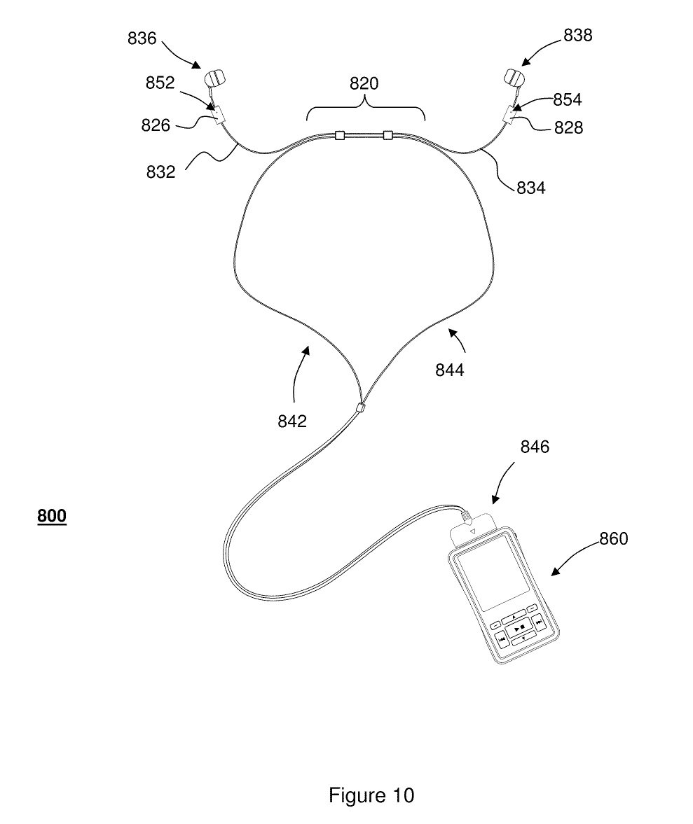

The hearing aid apparatus of FIG. 10 depicts an eighth example hearing aid frontend 800 connected with ear phones, this hearing aid frontend is substantially identical to that of FIG. 8, except that the curved body is replaced by the overlapping flexible cable portion of the example of FIG. 7. As the features of this frontend are substantially identical to that of the fifth and sixth examples, descriptions in relation to the sixth example frontend are incorporated herein by reference with the numerals added by 300 and 200 respectively where appropriate.

As most features are common to the various examples, appropriate numerals are impliedly incorporated into the individual figures with reference to the example number without loss of generality. Furthermore, as a common sound processor 160 can be used with the various examples, the sound processor is marked with the same numeral throughout without loss of generality.

In the examples of FIGS. 1-5 and 9, there is provided an audio signal output terminal associated with each microphone casing. More specifically, there is a length of flexible cable portion connecting a signal output (including an ear piece) with a corresponding microphone casing. As each audio signal output terminal received audio signal output from the sound processor 160, this arrangement provides useful choice to a user since the user may elect to use either one or both of the signal outputs for increased flexibility.

In the examples of FIGS. 6 to 9, there is provided an audio signal output terminal associated with each microphone casing. More specifically, there is a length of flexible cable portion connecting a signal output (including an ear piece) with a corresponding microphone casing. In those examples, the positions of the microphone casings (and hence the sound collectors) are substantially predetermined by the length of the flexible cable portion, although a small extent of variation is possible because the transverse separations of the microphone housings are user adjustable, and the adjustment is pivotally about a corresponding output terminal due to the flexible linkage.

While various examples of hearing aid frontends and apparatus have been described above with reference to the Figures, it will be appreciated that the examples are non-limiting and are only provided for reference to persons skilled in the art who would of course understand that various modifications could be made within the scope of disclosure without loss of generality. For example, while a fixed beamforming technique is used for exemplary frontend signal process, other beamforming techniques can be used without loss of generality.

Table of Numerals

| | | | | | | | | |
|---|---|---|---|---|---|---|---|---|
| 110 | | | 410 | | 610 | 710 | | Neck-mount portion |
| | 220 | | | | | | | Curved body |
| | | 320 | | | | | | Flexible body |
| | | | | 520 | | | 820 | Flexible cable portion |
| 122 | 222 | | 422 | | 622 | 722 | | First curved arm |
| 124 | 224 | | 424 | | 624 | 724 | | Second curved arm |
| 126 | 226 | 326 | 426 | 526 | 626 | 726 | 826 | Microphone casing |
| 128 | 228 | 328 | 428 | 528 | 628 | 728 | 828 | |
| 132 | 232 | 332 | 432 | 532 | 632 | 732 | 832 | Flexible cable portion |
| 134 | 234 | 334 | 434 | 534 | 634 | 734 | 834 | |
| 136 | 236 | 336 | 436 | 536 | | | | Signal output terminal |
| 138 | 238 | 338 | 438 | 538 | | | | |
| | | | | | 636 | 736 | 836 | Ear phone |
| | | | | | 638 | 738 | 838 | |
| 142 | 242 | 342 | 442 | 542 | 642 | 742 | 842 | Flexible cable portion |
| 144 | 244 | 344 | 444 | 544 | 644 | 744 | 844 | |
| 146 | 246 | 346 | 446 | 546 | 646 | 746 | 846 | Signal connector |
| 152 | 252 | 352 | 452 | 552 | 652 | 752 | 852 | Aperture |
| 154 | 254 | 354 | 454 | 554 | 654 | 754 | 854 | |
| 160 | 260 | 360 | 460 | 560 | 660 | 760 | 860 | Sound processor |

1. A hearing aid frontend device for wearing use by a user comprising first and second sound collectors adapted for collecting ambient sound and a sound processor for processing sounds collected by the first and second collectors, wherein the first and second sound collectors are arranged such that the transverse separation distance between the sound collectors during use is greater than the face width of a user, and wherein the sound processor is adapted to process the ambient sounds collected by the first and second sound collectors and select sounds forward of the user for subsequent noise cancellation and output to the user.

2. A hearing aid frontend device according to claim 1, wherein the sound processor is adapted to process sounds collected by the first and second sound collectors using beamforming techniques to a forward sound output.

3. A hearing aid frontend according to claim 1, wherein the forward sound output is subject to adaptive noise cancellation.

4. A hearing aid frontend according to claim 1, wherein the sound processor is adapted to select sounds of within ±30 degrees of the forward axis of the user.

5. A hearing aid frontend according to claim 1, wherein the sound collector comprises a microphone.

6. A hearing aid frontend according to claim 5, wherein the microphone comprises a condenser microphone.

7. A hearing aid frontend according to claim 1, wherein the sound collector is housed within a casing, and wherein an aperture in communication with the sound collector and having an aperture axis defining a forward direction is formed on the casing.

8. A hearing aid frontend according to claim 1, wherein each of the sound collectors is mounted on a flexible cable such that the separation between the sound collectors is user adjustable or variable.

9. A hearing aid frontend according to claim 1, wherein the transverse separation distance between the first and second sound collectors is user adjustable.

10. A hearing aid frontend according to claim 1, wherein the first and second sound collectors are mounted at ends of a rigid or semi-rigid mounting frame, the transverse separation distances of the ends of the mounting frame being wider than that of the face of a user.

11. A hearing aid apparatus comprising a hearing aid frontend according to claim 1 and a pair of ear phones connected to the sound cancellation output of the hearing aid frontend.

12. A hearing aid apparatus according to claim 11, wherein there is a flexible cable portion interconnecting an ear phone and a sound collector such that the sound collector is downwardly dependent from the ear phone during use.

13. A hearing aid apparatus according to claim 12, wherein the length of the flexible cable portion is such that the sound collector is suspended at a level proximal the neck portion of the user during use.

14. A hearing aid apparatus according to claim 11, wherein the sound collector is connected to first and second flexible cable portions, wherein the first flexible cable portion interconnects the sound collector and the ear phone, and the second flexible cable portion connects the sound collector to a knot of a flexible cable loop; and wherein the flexible cable loop is adapted for neck wearing by a user.

15. A hearing aid apparatus according to claim 14, wherein the knot is adjustable to vary the length of the second cable portions.

16. A hearing aid apparatus according to claim 11, wherein the sound collectors are relatively moveable to vary transverse separation for spatial selectivity.

17. A hearing aid apparatus according to claim 11, wherein each sound collector is intermediate first and second flexible cable portions and each sound collector is moveable relative to the ear of a user during use to vary separation distance of the sound collectors.
